(19) United States
(12) Patent Application Publication
(10) Pub. No.: US 2026/0063207 A1
(43) Pub. Date: Mar. 5, 2026

(54) SEAL CARTRIDGE, SEAL CARTRIDGE ASSEMBLY, AND METHOD OF USE

(71) Applicant: Caterpillar Inc., Peoria, IL (US)

(72) Inventors: Gabriel S. FERREIRA, Peoria, IL (US); Wesley A. THILL, Peoria, IL (US); Phillip J. KUNZ, Morton, IL (US)

(73) Assignee: Caterpillar Inc., Peoria, IL (US)

(21) Appl. No.: 18/817,477

(22) Filed: Aug. 28, 2024

(51) Int. Cl. F16J 15/34; F16N 11/00

(52) U.S. Cl. CPC F16J 15/3404; F16N 11/00; F16N 2210/00

(57) ABSTRACT

A seal cartridge assembly of a sealing system may include a seal cartridge having a first side surface, a second side surface, opposite to the first side surface, a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion, and at least one grease passage having one opening on the first side surface and another opening on the protrusion portion of the circumferential inner surface. The assembly may also include a first seal provided within the first seal-receiving portion of the circumferential inner surface, and a second seal provided within the second seal-receiving portion the circumferential inner surface.

### TECHNICAL FIELD

The present disclosure relates generally to a seal cartridge for a machine, and, more particularly, to a seal cartridge having at least one grease passage and a related seal cartridge assembly and method of using a seal cartridge assembly.

### BACKGROUND

Transmission systems, used in a variety of applications, including machinery, tend to be negatively impacted by high contamination environments, which can reduce the overall life of components of the transmission systems. While components of such systems capable of withstanding such high contamination environments have been created, such components have proven to be highly susceptible to system variations (e.g., transmission systems of different machines vary in rotational speeds, temperatures, environmental requirements, and machine specifications). In addition, such components may be relatively expensive to manufacture, negating some of the value of the component. In addition, servicing of components of currently used seal assemblies is expensive and time consuming. Further, if the housing for seals of seal assemblies becomes damaged, users may need to incur additional costs for repair or machine out a new housing, which may require relatively larger parts that are not easily available.

Chinese Patent No. 110131415B (“the '415 patent”) describes a tensioner for a belt drive stop start motor, the tensioner includes a cartridge type sealing structure for sealing an opening of an annular space. The cartridge type sealing structure includes a dust-proof ring fixed to a rotating portion and a seal fixed to a fixing portion, the dust-proof ring and sealing lips of the seal define an oil chamber that is filled with grease. That is, the '415 patent describes a seal being used to keep grease within the oil cavity. There is a need, however, for a sealing system having parts that are relatively easy to manufacture and replace, and that is capable of moving or purging contaminants away from a main seal to protect the main seal.

The seal cartridge, seal cartridge assembly, and related method of use of the present disclosure may solve one or more of the problems set forth above and/or other problems in the art. The scope of the current disclosure, however, is defined by the attached claims, and not by the ability to solve any specific problem.

### SUMMARY

In one aspect of the present disclosure, a seal cartridge may include a first side surface, a second side surface, opposite to the first side surface, and a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion. The seal cartridge may also include at least one grease passage having one opening on the first side surface and another opening on the protrusion portion of the circumferential inner surface.

In another aspect of the present disclosure, a seal cartridge assembly of a sealing system may include a seal cartridge having a first side surface, a second side surface, opposite to the first side surface, and a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion. The seal cartridge also has at least one grease passage having one opening on the first side surface and another opening on the protrusion portion of the circumferential inner surface. The seal cartridge assembly may further include a first seal provided within the first seal-receiving portion of the circumferential inner surface and a second seal provided within the second seal-receiving portion the circumferential inner surface.

In still another aspect of the present disclosure, a method of using a seal cartridge assembly for a cylindrical shaft is described. The seal cartridge assembly includes a seal cartridge having: a first side surface, a second side surface, opposite to the first side surface, a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion, and at least one grease passage having one opening on the first side surface and another opening on the protrusion portion of the circumferential inner surface, the seal cartridge assembly further including a first seal provided within the first seal-receiving portion of the circumferential inner surface, and a second seal provided within the second seal-receiving portion of the circumferential inner surface. The method may include placing the seal cartridge, the first seal, and the second seal onto the cylindrical shaft, thereby sealing a first side of the cylindrical shaft and a second side of the cylindrical shaft and forming a greasing area between the circumferential inner surface of the seal cartridge, the first seal, the second seal, and the cylindrical shaft; and supplying grease to the greasing area via the at least one grease passage, the supplying the grease including expelling contents of the greasing area towards and around the first seal, toward the first side of the cylindrical shaft, and thereby replacing the contents of the greasing area with the supplied grease.

### BRIEF DESCRIPTION OF THE DRAWINGS

FIG. 1 shows a schematic isometric view of a motorgrader, as an example of a machine having a transmission system, including a seal cartridge assembly, in accordance with the present disclosure.

FIG. 2 is a schematic side view of a portion of a seal cartridge assembly, in accordance with the present disclosure.

FIG. 3 shows a schematic isometric view of the seal cartridge assembly shown in FIG. 2.

FIG. 4 is a schematic isometric cut-away cross-sectional view of the seal cartridge assembly shown in FIGS. 2 and 3.

FIG. 5 shows a flow chart of a method of using a seal cartridge assembly, in accordance with the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value, unless a variation amount is otherwise stated.

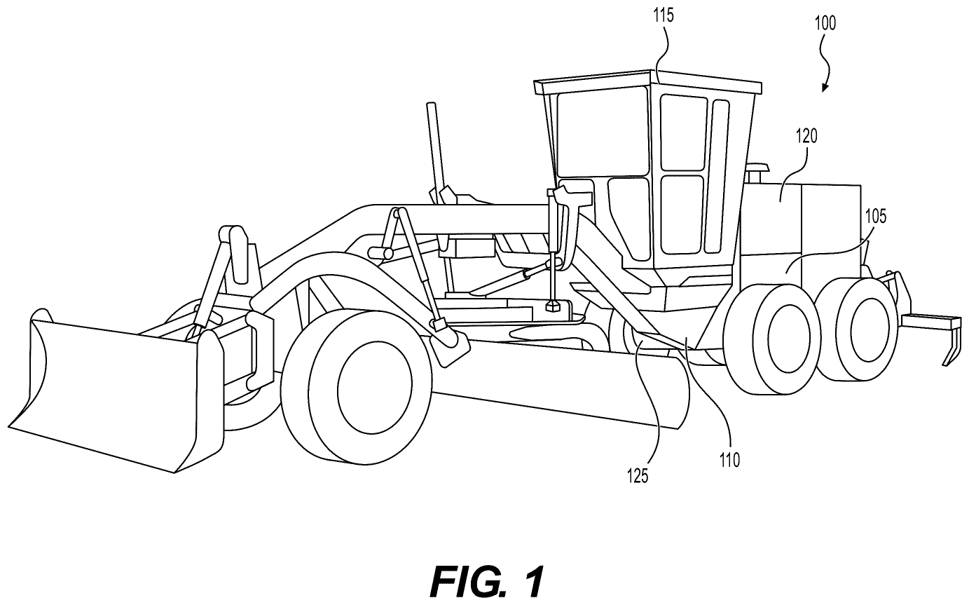

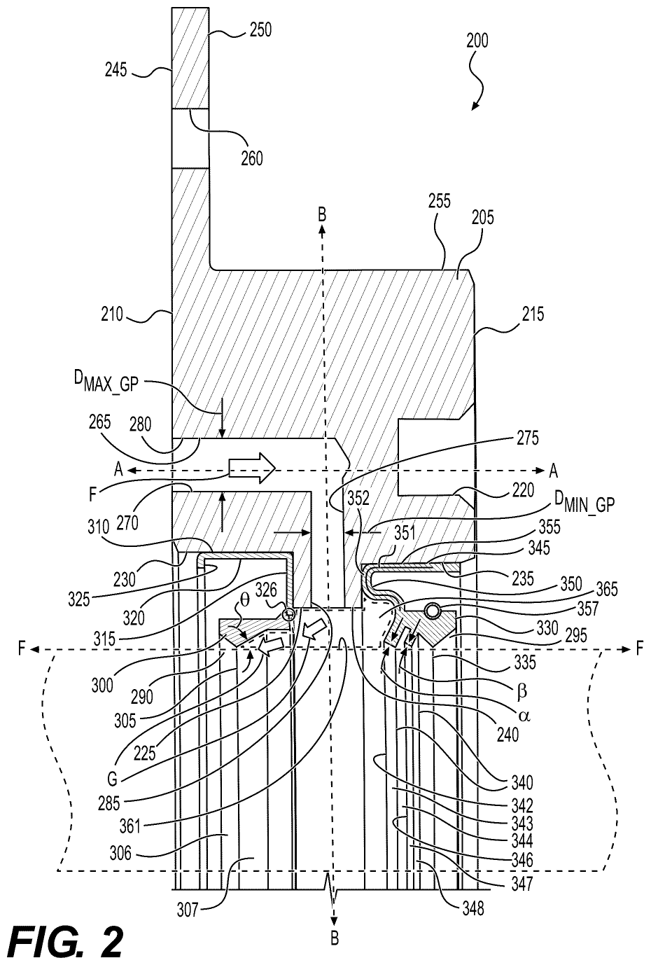

FIG. 1 shows a schematic isometric view of a motorgrader 100, as an example of a machine having a transmission system 105 including a seal cartridge assembly 200, shown in FIG. 2, in accordance with the present disclosure. The motorgrader 100 also has a frame 110, an operator station 115, an engine 120, and a drive system 125. During operation, the engine 120 may generate a power output directed to the transmission system 105, which, in turn, outputs the power to the drive system 125, to move the motorgrader 100 forwards or backwards.

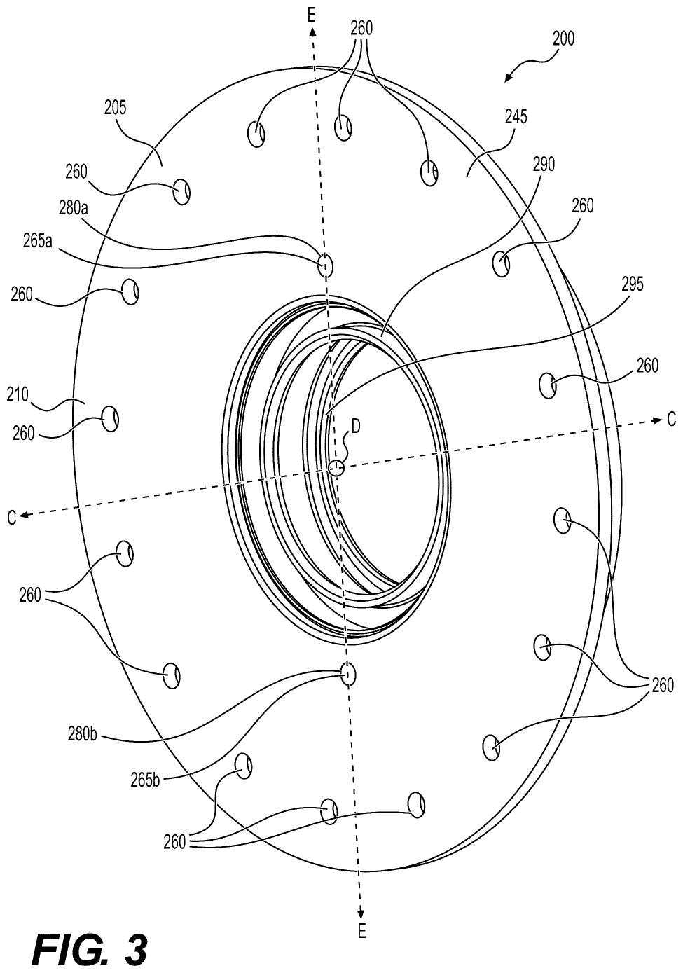

FIG. 2 shows a schematic side view of a portion of the seal cartridge assembly 200. The seal cartridge assembly 200 includes a seal cartridge 205 that is annular or ring-shaped (as shown in FIG. 3), and which has a first side surface 210, which faces an outboard side (also referred to as an air side) of the transmission system 105, and a second side surface 215, opposite to the first side surface 210, and which faces an inboard side (or a fluid side) of the transmission system 105. The seal cartridge 205 may be formed of a material that has a relatively low coefficient of thermal expansion. As one specific example, the material that forms the seal cartridge 205 may be steel.

The second side surface 215 of the seal cartridge 205 may include one or more blind holes 220, also referred to as alignment blind holes, which may be configured to align with protrusions (for example, cotter pins) (not shown) on a portion of the transmission system 105 for proper alignment of the seal cartridge 205 and seal cartridge assembly 200 within the transmission system 105. The seal cartridge 205 also has a circumferential inner surface 225 that extends from the first side surface 210 to the second side surface 215. The circumferential inner surface 225 has a first seal-receiving portion 230, adjacent to the first side surface 210, a second seal-receiving portion 235, adjacent to the second side surface 215, and a protrusion portion 240 that is in between the first seal-receiving portion 230 and the second seal-receiving portion 235. The protrusion portion 240 includes at least a portion of a grease passage 265, discussed below, and provides a positive stop for both a first seal 290 and a second seal 295 to be installed in the seal cartridge 205 in a consistent manner, preventing installation depth variation. In addition, the seal cartridge 205 has a radially extending, disc-shaped securing flange 245, which is defined in part by the first side surface 210. The flange 245 is also defined by a flange inner surface 250. Flange 245 may extend radially from an outer circumferential surface 255 of the seal cartridge 205, and may include one or more openings 260, which may be used to secure the seal cartridge assembly 200 within the transmission system 105 using bolts and/or other hardware (not shown).

The seal cartridge 205 also has at least one grease passage 265, which may have any one of a variety of configurations or shapes. In the embodiment shown in FIG. 2, as an example, the grease passage 265 may have an “L-shape,” with a first portion 270 extending along an axis A-A extending from the first side surface 210 to the second side surface 215, and a second portion 275 extending along an axis B-B, perpendicular to the axis A-A. The first portion 270 of the grease passage 265 may be collinear with one of the one or more alignment blind holes 220 used to align the seal cartridge assembly 200 within the transmission system 105. That is, as shown in FIG. 2, the first portion 270 of the grease passage 265 and the blind hole 220 may be collinear, at least in part, along axis A-A, extending from the first side surface 210 to the second side surface 215, or an axis that is normal to the first side surface 210 and the second side surface 215.

Although the embodiment shown in FIG. 2 shows the first portion 270 and the second portion 275 of the grease passage 265 being perpendicular to each other, the first portion 270 and the second portion 275 may be angled relative to each other. That is, the second portion 275 may extend along an axis that is at an angle relative to the axis A-A, with the angle being greater than or less than 90°. The grease passage 265 may have a first opening 280 on the first side surface 210 of the seal cartridge 205 and a second opening 285 on the protrusion portion 240 of the circumferential inner surface 225. The first opening 280 faces the outboard side of the transmission system 105, and the second opening faces a greasing area 365, described in more detail below. In addition, the first opening 280 of the grease passage 265 may be plugged by a grease fitting (not shown), to prevent grease supplied to the grease passage 265 from moving back through the first opening 280 after being supplied to the grease passage 265. The first portion 270 and the second portion 275 of the grease passage 265 may have different diameters, with a maximum diameter D_{MAX_GP} within the first portion 270 and a minimum diameter D_{MIN_GP} within the second portion 275. As an example, the maximum diameter D_{MAX_GP} may be in a range of about 6 mm to about 10 mm, or about 8 mm. In other embodiments, the first portion 270 and the second portion 275 of the grease passage 265 may have the same diameter, or the diameter of the second portion 275 may be greater than the diameter of the first portion 270 of the grease passage 265. The grease passage 265 serves as a separator between the first seal 290 and the second seal 295, and helps to “funnel” the grease towards the grease sealing lip 305 of the first seal 290, while also helping to prevent grease from getting lodged between portions of the first seal 290, portions of the second seal 295, and the seal cartridge 205.

FIG. 2 further shows a first seal 290 and a second seal 295 of the seal cartridge assembly 200. The first seal 290 is shown positioned within the first seal-receiving portion 230 of the circumferential inner surface 225, and the second seal 295 is shown positioned within the second seal-receiving portion 235 of the circumferential inner surface 225. The first seal 290 faces the outboard side (air side) 130 of the transmission system 105, and the second seal 295 faces the inboard side (oil side) of the transmission system 105. The first seal 290 may also be referred to as a dust excluder seal, and serves to allow for purging of contents from a greasing area 365, defined as the space between the circumferential inner surface 225 of the seal cartridge 205, the first seal 290, the second seal 295, and a cylindrical shaft 360, to the air side. The second seal 295 may also be referred to as a main seal, and serves to maintain oil on the oil side and to limit passage of contents of the greasing area 365 from passing to the oil side and to limit passage of oil from the oil side into the greasing area.

The first seal 290 may have an inner portion 300 with at least one inner protrusion or grease sealing lip 305, and an outer portion 310 with a radial portion 315, extending radially outward from the inner portion 300, a longitudinal portion 320, extending from the radial portion 315 and longitudinally along the first seal-receiving portion 230 of the circumferential inner surface 225, and an outer lip 325 extending radially inward from the longitudinal portion 320. The outer portion 310 of the first seal 290 may be formed of a rigid material, such as steel, and the inner portion 300 may be formed of a flexible material, such as an elastomer. The outer portion 310 may, for example, be referred to as a steel can, and the inner portion 300 may, for example, be referred to as an elastomer. The point at which the outer portion 310 and the inner portion 300 of the first seal 290 meet may be referred to as a hinge 326. As discussed below, the hinge 326 is the point on the first seal 290 about which the grease sealing lip 305 bends or moves due to pressure of the contents of greasing area 365. The inner portion 300 and the outer portion may be attached to each other using bonding, such as phosphate bonding.

The second seal 295 may have an inner portion 330 with an oil side sealing lip 335 and two inner grease sealing lips 340 and 341, and an outer portion 345 with a radial portion 350, extending radially outward from the inner portion 330, and a longitudinal portion 355, extending from the radial portion 350 and longitudinally along the second seal-receiving portion 235 of the circumferential inner surface. The outer portion 345 of the second seal 295 may include an inner rigid portion 351, which may be formed of a rigid material, such as steel, in combination with an outer coating 352, which may be formed of a flexible material, such as an elastomer, and the inner portion 330 may be formed of a flexible material, such as an elastomer. As a specific example, the outer portion 345 may be formed of elastomer coated steel, and the inner portion 330 may be formed of elastomer. The second seal 295 may also include a spring portion 357, nested within a back surface of the inner portion 330, as shown in FIG. 2. The spring portion 357 may be a garter spring, for example.

Each of the first seal 290 and the second seal 295 may be made of a single material or of multiple materials, for example, two materials. More specifically, the outer portion 310 of the first seal 290 may be formed of a first material having a relatively high rigidity, such as steel, as described above, and the inner portion 300 of the first seal 290 may be formed of a second material having a relatively high flexibility, such as an elastomer, as discussed above. More specifically, the elastomer may be, for example, Fluorine Kautschuk Material (FKM), nitrile butadiene rubber (NBR), Hydrogenated Nitrile Butadiene Rubber (HNBR), Carboxylated Nitrile Rubber (XNBR), Silicone, or polyacrylate rubber (ACM). Similarly, the second seal 295 may be formed of two materials, including first material having relatively high rigidity, such as steel, and a second material having relatively high flexibility, such as an elastomer. More specifically, for example, the elastomer may be Fluorine Kautschuk Material (FKM), nitrile butadiene rubber (NBR), Hydrogenated Nitrile Butadiene Rubber (HNBR), Carboxylated Nitrile Rubber (XNBR), Silicone, or polyacrylate rubber (ACM). The first materials of the first seal 290 and the second seal 295 may be the same material, or they may be different materials, and similarly, the second materials of the first seal 290 and the second material of the second seal 295 may be the same material or they may be different materials.

In the embodiment shown in FIGS. 2 to 4, the first seal 290 has relatively fewer grease sealing lips than the second seal 295. Specifically, the first seal 290 has one grease sealing lip 305, and the second seal 295 has two grease sealing lips 340 and 341. In addition, the grease sealing lip 305 of the first seal 290 has an air side surface 306 and a grease side surface 307, with the grease side surface 307 being defined by a surface area and an angle θ measured relative to a longitudinal axis F-F that is parallel to a surface 361 of a cylindrical shaft 360, the surface 361 of the cylindrical shaft 360 defining, in part, the greasing area 365. One grease sealing lip 340 of the second seal 295 has a grease side surface 342, a shaft facing edge 343, and an oil side surface 344, with the shaft facing edge 343 being defined by a surface area and an angle α relative to longitudinal axis F-F. The other grease sealing lip 341 of the second seal 295 has a grease side surface 346, a shaft facing edge 347, and an oil side surface 348, with the shaft facing edge 347 being defined by a surface area and an angle β relative to the surface 361 of the cylindrical shaft 360. In one embodiment, the surface area of the grease side surface 307 is greater than a surface area of each of the shaft facing edge 343 of the first grease sealing lip 340 and the shaft facing edge 347 of the second grease sealing lip 341. In addition, the angle θ is greater than each of α and β.

By virtue of the grease sealing lip 305 of the first seal 290 having a relatively greater surface area and a relatively lower angle between grease side surface 307 and surface 361, as compared to those of the shaft facing edges 343 and 347 of the grease sealing lips 340 and 341, the force of pressure of the contents of the greasing area 365 is greater on the grease side surface 307 of the grease sealing lip 305 of the first seal 290 as compared to that force on the shaft facing edges 343 and 347 of the grease sealing lips 340 and 341 of the second seal 295. Further, the force of pressure of the contents of the greasing area 365 on at least the grease side surface 342 of the first grease sealing lip 340 of the second seal 295 pushes the first grease sealing lip 340 rightward and downward, with reference to FIG. 2, urging the first grease sealing lip 340 against the cylindrical shaft 360 and countering the force acting on the shaft facing edge 343. Thus, the contents of the greasing area 365 are more apt to move the grease sealing lip 305 of the first seal 290 away from the cylindrical shaft 360, than to move the grease sealing lips 340 and 341 of the second seal away from the cylindrical shaft.

Further, by virtue of the first seal 290 having a hinge 326 between the inner portion 300, which includes the grease sealing lip 305, and the outer portion 310, and the second seal 295 having no such hinge, the grease sealing lip 305 of the first seal is more apt to move due to the force of the contents of the greasing area 365 as compared to the grease sealing lips 340 and 341 of the second seal 295.

Still further, the first seal 290 is installed within the seal cartridge 205 in a “backwards” configuration, with the longitudinal portion 320 and the radial portion 315 of the first seal 290 contacting the first seal-receiving portion 230 of the circumferential inner surface 225 of the seal cartridge 205, and the second seal 295 is installed in a “forwards” configuration, with the radial portion 350 and the longitudinal portion 355 contacting the second seal-receiving portion 235 of the circumferential inner surface 225 of the seal cartridge 205. In other words, the first seal 290 and the second seal 295 may installed in a “back-to-back” configuration, as shown in FIG. 2.

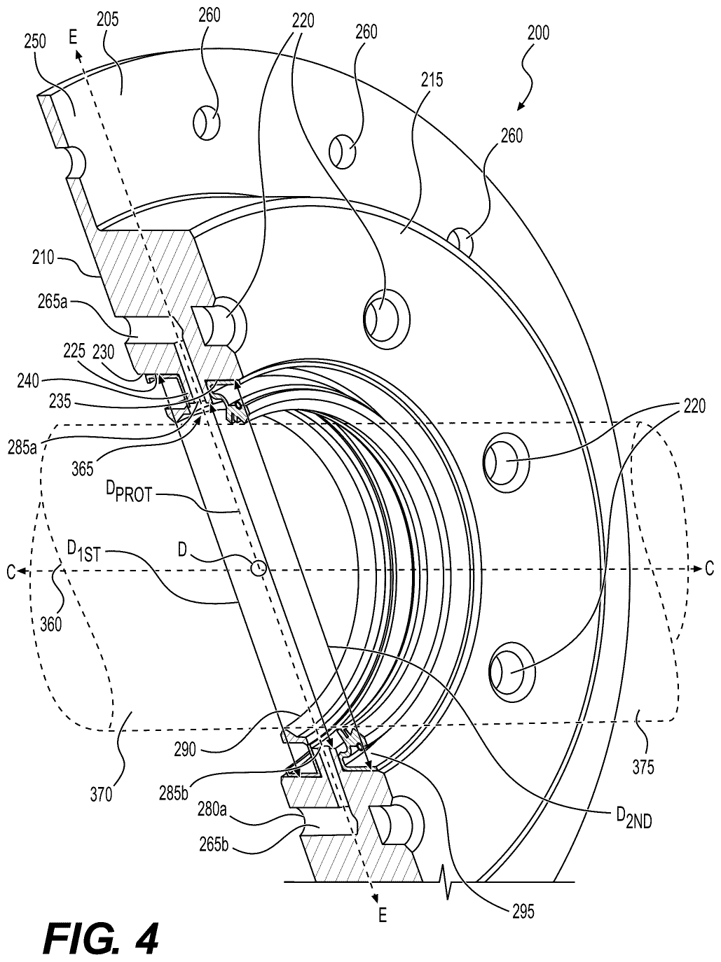

As also shown in FIG. 2, the second opening 285 of the grease passage 265 is in between the first seal 290 and the second seal 295. By virtue of this arrangement, when a cylindrical shaft 360 (shown in dashed lines in FIG. 4) is inserted through the seal cartridge, the first seal 290, and the second seal 295, grease may be pushed through the seal cartridge 205 into a greasing area 365 (shown in FIG. 4) between the seal cartridge 205, the first seal 290, and the second seal 295. The greasing area 365 forms a circumferential ring around the cylindrical shaft 360 between the first seal 290 and the second seal 295.

The grease sealing lip design and orientation of the first seal 290 creates a path of least resistance for the grease, which allows the grease pushed into the greasing area 365 to be purged or to move outward, past the first seal 290, taking contaminants (e.g., dust) outward and away from the second seal 295. Further, although the second seal 295 includes the spring portion 357, such as a garter spring, the first seal 290 does not use a garter spring, thus making the first seal 290 more malleable and less prone to retain the contents of the greasing area 365, including grease and debris, as compared to the second seal 295. In addition, the relative surface areas and angles of the grease sealing lips of the installed first seal 290 and second seal 295, as well as the relative number of grease sealing lips of the first seal 290 and the second seal 295 allows for the force of the pressure of the contents of the greasing area 365 to push the grease sealing lip 305 of the first seal 290 open and away from the cylindrical shaft 360, and thus, lets the contents of the greasing area 365 pass the grease sealing lip 305, while limiting that same force from pushing the grease sealing lips 340 and 341 of the second seal 295 away from the cylindrical shaft. Put another way, the configuration of the grease sealing lip 305 of the first seal, including there being a single grease sealing lip 305, and the orientation of the first seal 290 allow the contents of the greasing area 365 to push the grease sealing lip 305 open by causing the inner portion 300 of the first seal 290 to move or rotate about the hinge 326 where it is bonded to the outer portion 310 of the first seal 290, while the configuration of the grease sealing lips 340 and 341 of the second seal 295, including there being two grease sealing lips 340 and 341, and the orientation of the second seal 295 limit or reduce grease within the greasing area from pushing open the grease sealing lips 340 and 341 of the second seal 295.

In addition, the first seal has a “grease pumping” capability, which involves the interaction of microsasperities of the flexible material portion of the first seal 290 and microsasperities of the shaft 360. These relative microasperities allow for grease to get pumped or pushed past the first seal 290, allowing for a constant thin film of grease to move past the grease sealing lip 305.

The grease within the greasing area 365 is pushed outward past the first seal 290 when additional grease is supplied to the greasing area 365 via the grease passage 265. More specifically, the grease also purges past the first seal 290 due to the increase in volume of grease when the additional grease is supplied to the greasing area 365, and thus, the increase in pressure and the resulting increase in force generated by the added grease in the greasing area 365. Due to the first seal 290 having relatively fewer grease sealing lips (e.g., one grease sealing lip 305) as compared to that of the second seal 295, and due to the first seal 290 being oriented or positioned in a manner in which the contents of the greasing area 365 force the inner portion 300 of the first seal 290 outwards and away from the cylindrical shaft 360, the increased pressure and force caused by the added grease will create a condition in which the grease sealing lip 305 will “open,” allowing for the contents of the greasing area 365 to be purged from the greasing area 365. Thus, adding grease to the seal cartridge assembly 200 via the grease passage 265 both purges grease and contaminants from the greasing area 365 and provides lubrication to the first seal 290 and to a cylindrical shaft 360 (shown in FIG. 4).

FIG. 3 shows a schematic isometric view of the seal cartridge assembly 200 shown in FIG. 2. In particular, FIG. 3 shows the seal cartridge 205, the first seal 290, and the second seal 295. The first side surface 210 of the seal cartridge 205 is shown with a plurality of the openings 260 in the flange 245 of the seal cartridge 205, and two first openings 280a and 280b to two grease passages 265a and 265b of the seal cartridge 205. As shown in FIG. 3, the two grease passages 265a and 265b are diametrically opposite (180 degrees) to one another relative to a central axis C-C of the seal cartridge 205, and through a center D of the seal cartridge 205 or, in other words, the grease passages 265a and 265b are arranged so that they are aligned along central axis C-C and along a vertical axis E-E, as shown in FIG. 3. In some embodiments, the two grease passages 265a and 265b are arranged so that they are evenly spaced on the first side surface 210. Although the seal cartridge 205 of the embodiment shown in FIG. 3 includes two grease passages 265a and 265b, one grease passage 265 or more than two grease passages 265 may be included. Further, although the two grease passages 265 may be diametrically opposite to one another, the grease passages 265 may be located in other configurations.

FIG. 4 is a schematic isometric cut-away cross-sectional view of the seal cartridge assembly 200 shown in FIGS. 2 and 3, as well as the cylindrical shaft 360 in dashed outline. In particular, FIG. 4 shows the seal cartridge 205, the first seal 290, and the second seal 295, and the cylindrical shaft 360 extending through centers of each of the seal cartridge (center D), the first seal 290, and the second seal 295. The second side surface 215 of the seal cartridge 205 is shown, including a plurality of alignment blind holes 220, and the flange inner surface 250 is shown, including the plurality of openings 260 for securing the seal cartridge 205 in place. FIG. 4 also shows the first seal 290 within the first seal-receiving portion 230, the second seal 295 within the second seal-receiving portion 235, and the protrusion portion 240 in between the first seal 290 and the second seal 295. When the seal cartridge 205, the first seal 290, and the second seal 295 are placed onto the cylindrical shaft 360 (or, alternatively, when the cylindrical shaft 360 is inserted through and placed within the circumferential inner surface 225 of the seal cartridge 205, the first seal 290, and the second seal 295), the greasing area 365 is formed between the circumferential inner surface 225, the first seal 290, the second seal 295, and the cylindrical shaft 360. One of the openings, specifically, the second opening 285, of the grease passage 265 faces, or opens to, the greasing area 365. In addition, each of a first side 370 of the cylindrical shaft 360 and a second side 375 of the cylindrical shaft 360 are sealed off from the greasing area 365.

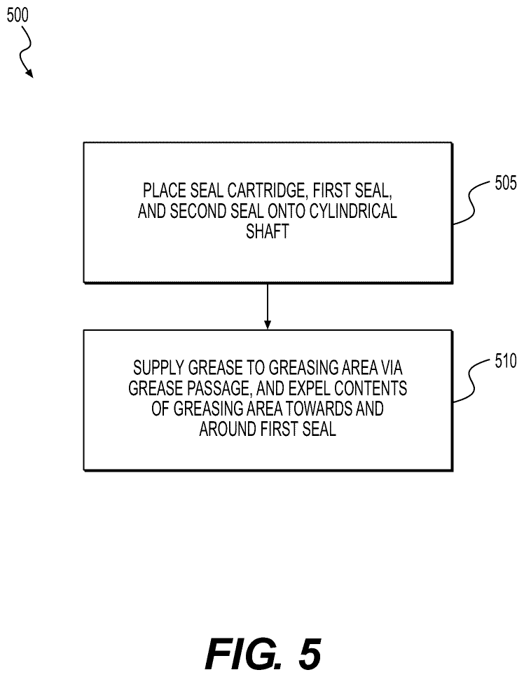

With reference to FIG. 2, and, as discussed in more detail below with reference to FIG. 5, when grease is supplied to the greasing area 365 via the grease passage 265, in the direction of arrow F, contents of the greasing area 365 (for example, previously-supplied grease, debris, including dust, dirt, grime, etc., or, if the greasing area 365 is being supplied with grease at a first instance, the contents may be air) are expelled from the greasing area 365 towards and around the first seal 290, in the direction of arrows G, in FIG. 2, toward the first side 370 of the cylindrical shaft 360, thereby replacing the contents of the greasing area 365 with newly-supplied grease. By virtue of this arrangement of the first seal 290 and the second seal 295 in the back-to-back configuration, the second seal 295 including a spring portion 357 while the first seal 290 includes no spring portion, the second seal 295 having a relatively greater number of grease sealing lips than the first seal 290, the ability of the first seal 290 to pump or push grease out of the greasing area 365, the forming of the greasing area 365 between the first seal 290 and the second seal 295, and by supplying grease to the greasing area 365, thereby increasing the volume of grease in the greasing area 365 and the pressure of same, contents of the greasing area 365, such as debris, may be easily expelled towards and through the first seal 290 (the dust excluder seal), while lubricating the cylindrical shaft 360 with grease, and limiting debris from moving towards or around the second seal 295, to the second side 375 of the cylindrical shaft 360.

Further, FIG. 4 shows portions of the grease passages 265a and 265b of the seal cartridge 205 shown in FIG. 3, specifically, a portion of the first grease passage 265a and a portion of the second grease passage 265b. FIG. 4 also provides an additional view of the first opening 280a and 280b of the first grease passage 265a and the second grease passage 265b, respectively, the first openings 280a and 280b being in the first side surface 210, and the second opening 285a and 285b of the first grease passage 265a and the second grease passage 265b, the second openings 285a and 285b being within the protrusion portion 240 of the circumferential inner surface 225. In addition. FIG. 4 shows the relative diameters of the first seal-receiving portion 230, the second seal-receiving portion 235, and the protrusion portion 240 of the circumferential inner surface 225 of the seal cartridge 205. In one embodiment, a diameter D_{1ST} of the first seal-receiving portion 230 is greater than a diameter D_{2ND} of the second seal-receiving portion 235, and the diameter D_{2ND} of the second seal-receiving portion 235 is greater than a diameter D_{PROT} of the protrusion portion 240. The relationship of the diameter D_{2ND} of the second seal-receiving portion 235 to the diameter D_{1ST} of the first seal-receiving portion 230 may differ (e.g., the diameters D_{1ST} and D_{2ND} may be equal to each other, or the second portion diameter D_{2ND} may be greater than the first portion D_{1ST}). The diameters of the first seal-receiving portion 230 and the second seal-receiving portion 235 may be adjusted to fit any seal suitable for use in transmission systems, and which would not impact the overall greasing or dust excluding capability of the seal cartridge assembly 200.

### Industrial Applicability

The seal cartridge 205 and seal cartridge assembly 200 of the present disclosure, and the related method of manufacture described below, can be used in sealing systems. Specifically, seal cartridge 205 and seal cartridge assembly 200 of the present disclosure can be used to remove debris, such as dust, dirt, grime, etc., in high contamination environments, such as transmission systems of machines, while being relatively easy to service, maintain, and replace. The seal cartridge 205 and seal cartridge assembly 200 are also relatively inexpensive to manufacture and require relatively less time for manufacture.

FIG. 5 a flow chart of a method 500 of using a seal cartridge assembly 200 for a cylindrical shaft 360, in accordance with the present disclosure. The method 500 includes a step 505 of placing the seal cartridge 205, the first seal 290, and the second seal 295 onto the cylindrical shaft 360 (or, alternatively, inserting the cylindrical shaft through the circumferential inner surface 225 of the seal cartridge 205, the first seal 290 and the second seal 295), thereby sealing the greasing area 365 formed between the circumferential inner surface 225 of the seal cartridge 205, the first seal 290, the second seal 295, and the cylindrical shaft 360, from the first side 370 and the second side 375 of the cylindrical shaft 360. More specifically, for example, step 505 may include installing the first seal 290 and the second seal 295 in the seal cartridge in a back-to-back configuration. The method 500 may also include a step 510 of supplying grease to the greasing area 365 via the grease passage 265. Supplying the grease may include expelling contents of the greasing area 365 (which may be air, in a first instance of supplying grease to the greasing area, or grease and debris, including dust, dirt, grime, etc., in a subsequent instance of supplying grease to the greasing area) to the outboard side of the transmission system 105.

Although the method 500 is described as including the steps 505 and 510 described above, and shown in FIG. 5, the method 500 may include additional steps and/or substeps. For example, including removing the seal cartridge 205 from a transmission system 105, removing seals from the removed seal cartridge 205, cleaning the seal cartridge 205 of all grease and debris that may be present, cleaning the cylindrical shaft 360 of all grease and debris that may be present, applying a thin coat of oil on the section of the cylindrical shaft 360 on which a first seal 290 will be placed or contacted, to help with seal break in, installing a new first seal 290 and a new second seal 295 in the seal cartridge 205. And, once the seal cartridge 205 with the first seal 290 and the second seal 295 have been placed onto the cylindrical shaft 360 in step 505, the method could also include installing mating hardware (including, for example, bolts and nuts), to retain the seal cartridge 205 in place. Further, the method may include, after the step 510 of supplying grease to the greasing area 365, visually confirming the expulsion of a small amount of grease near the first seal 290, to indicate that the greasing area 365 is properly filled with grease, and helping with seal break in for the first seal 290.

By virtue of the seal cartridge 205, seal cartridge assembly 200, and related method 500 of use of the present disclosure, it is possible to provide a seal cartridge assembly 200 capable of removing debris and contamination away from a main seal (i.e., a second seal 295). That is, by allowing the grease to flow towards and around the dust excluder seal (i.e., a first seal 290) and away from the main seal (i.e., second seal 295), debris, including dust, grime, dirt, etc., is expelled away from the main seal, thus reducing wear and contamination of the main seal, providing a relatively cleaner environment in which the main seal operates, and prolonging the life of the main seal. The grease also lubricates a lip 325 of an outer portion 310 of the first seal 290, as the dust excluder seal, while also acting as a protective barrier for the second seal 295, as the main seal. Further, the seal cartridge assembly 200 of the present disclosure is relatively easy to service and maintain independent of other components of a broader system (e.g., a transmission system), and the components of the assembly, namely, the seal cartridge 205, the first seal 290, and the second seal 295, can be easily replaced with relatively low cost.

It will be apparent to those skilled in the art that various modifications and variations can be made to the disclosed seal cartridge and related seal cartridge assembly and method of use, without departing from the scope of the disclosure. Other embodiments of the seal cartridge and the related seal cartridge assembly and method of use will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

1. A seal cartridge comprising:
a first side surface;
a second side surface, opposite to the first side surface;
a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion; and
at least one grease passage having one opening on the first side surface and another opening on the protrusion portion of the circumferential inner surface.

2. The seal cartridge of claim 1, wherein the at least one grease passage includes two grease passages, the two grease passages being diametrically opposite to one another relative to a center of the seal cartridge.

3. The seal cartridge of claim 1, wherein a maximum diameter of the at least one grease passage is about 8 mm.

4. The seal cartridge of claim 1, further comprising one or more blind holes formed in the second side surface, the one or more blind holes being configured to align with protrusions of a portion of a transmission system for proper alignment of the seal cartridge.

5. The seal cartridge of claim 1, wherein a diameter of the first seal-receiving portion is greater than a diameter of the second seal-receiving portion, and the diameter of the second seal-receiving portion is greater than a diameter of the protrusion portion.

6. The seal cartridge of claim 1, further comprising a radially extending, disc-shaped securing flange defined, in part, by the first side surface.

7. A seal cartridge assembly of a sealing system, the seal cartridge assembly comprising:
a seal cartridge having:
a first side surface;
a second side surface, opposite to the first side surface;
a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion; and
at least one grease passage having one opening on the first side surface and another opening on the protrusion portion of the circumferential inner surface;
a first seal provided within the first seal-receiving portion of the circumferential inner surface; and
a second seal provided within the second seal-receiving portion the circumferential inner surface.

8. The seal cartridge assembly of claim 7, wherein the first seal includes one grease sealing lip and the second seal includes two or more grease sealing lips.

9. The seal cartridge assembly of claim 8, wherein a surface area of a grease side surface of the one grease sealing lip of the first seal is greater than a surface area of a grease side surface of each of the two or more grease sealing lips of the second seal.

10. The seal cartridge assembly of claim 8, wherein an angle of a grease side surface of the one grease sealing lip of the first seal relative to a longitudinal axis is greater than an angle of a grease side surface of each of the two or more grease sealing lips of the second seal.

11. The seal cartridge assembly of claim 7, wherein only the second seal includes a garter spring.

12. The seal cartridge assembly of claim 7, wherein the at least one grease passage includes two grease passages, the two grease passages being diametrically opposite to one another relative to a center of the seal cartridge.

13. The seal cartridge assembly of claim 7, wherein a maximum diameter of the at least one grease passage is about 8 mm.

14. The seal cartridge assembly of claim 7, further comprising one or more blind holes, formed in the second side surface, the one or more blind holes being configured to align with protrusions of a portion of a transmission system for proper alignment of the seal cartridge.

15. The seal cartridge assembly of claim 7, wherein a diameter of the first portion is greater than a diameter of the second portion, and the diameter of the second portion is greater than a diameter of the protrusion portion.

16. The seal cartridge assembly of claim 7, wherein the seal cartridge further has a radially extending, disc-shaped securing flange defined, in part, by the first side surface.

17. The seal cartridge assembly of claim 7, wherein the first seal is a dust excluder seal and the second seal is a main seal.

18. A method of using a seal cartridge assembly for a cylindrical shaft, the seal cartridge assembly including a seal cartridge having: a first side surface, a second side surface, opposite to the first side surface, a circumferential inner surface extending from the first side surface to the second side surface, the circumferential inner surface having a first seal-receiving portion, adjacent to the first side surface, a second seal-receiving portion, adjacent to the second side surface, and a protrusion portion between the first seal-receiving portion and the second seal-receiving portion, and at least one grease passage having one opening on the first side surface and another opening on the protrusion portion of the circumferential inner surface, the seal cartridge assembly further including a first seal provided within the first seal-receiving portion of the circumferential inner surface, and a second seal provided within the second seal-receiving portion of the circumferential inner surface, the method comprising:
placing the seal cartridge, the first seal, and the second seal onto the cylindrical shaft, thereby sealing a first side of the cylindrical shaft and a second side of the cylindrical shaft and forming a greasing area between the circumferential inner surface of the seal cartridge, the first seal, the second seal, and the cylindrical shaft; and
supplying grease to the greasing area via the at least one grease passage, the supplying the grease including expelling contents of the greasing area towards and around the first seal, toward the first side of the cylindrical shaft, and thereby replacing the contents of the greasing area with the supplied grease.

19. The method of claim 18, further comprising a step of installing the first seal and the second seal in the seal cartridge, wherein the first seal and the second seal are arranged in a back-to-back configuration.

20. The method of claim 18, wherein the first seal includes one grease sealing lip and the second seal includes two or more grease sealing lips, wherein a surface area of a grease side surface of the one grease sealing lip of the first seal is greater than a surface area of a grease side surface of each of the two or more grease sealing lips of the second seal, and wherein an angle of a grease side surface of the one grease sealing lip of the first seal relative to a longitudinal axis is greater than an angle of a grease side surface of each of the two or more grease sealing lips of the second seal.
